(19) United States
(12) Patent Application Publication
(10) Pub. No.: US 2003/0154119 A1
(43) Pub. Date: Aug. 14, 2003

(54) Online method and system for issuing vehicle repossession assignments to vehicle repossession contractors

(75) Inventors: Jason Stoliker, Plymouth, MI (US); James D. Westbrook, Canton, MI (US); Kevin Collins, Troy, MI (US); Raymond Edward Roberts, Canton, MI (US)

Correspondence Address: BROOKS & KUSHMAN P.C./FGTL, 1000 TOWN CENTER, 22ND FLOOR, SOUTHFIELD, MI, 48075, US

(73) Assignee: Ford Motor Company, Dearborn, MI (US)

(21) Appl. No.: 09/683,772

(22) Filed: Feb. 13, 2002

(51) Int. Cl. G06F 17/60

(52) U.S. Cl. 705/9

(57) ABSTRACT

An online method and system for issuing vehicle repossession assignments to vehicle repossession contractors. The invention includes at least one server computer configured to host a secure online account for a vehicle repossession contractor. The online account is remotely and securely accessible by the contractor and maintains at least one vehicle repossession assignment assigned to the contractor. Vehicle repossession agents access the server computer, define contractor profiles and assign new vehicle repossession assignments to contractors via the contractor's online accounts. Contractors remotely access their online accounts to receive new repossession assignments, accept or reject the assignments, and input feedback regarding a completed repossession assignment. Server computer may be additionally configured to page or otherwise initiate notification to a contractor that a new repossession assignment is pending at the contractor's online account.

### BACKGROUND OF INVENTION

1. Field of the Invention

This invention relates generally to electronic data processing and, more particularly, to an online method and system for issuing vehicle repossession assignments to vehicle repossession contractors.

2. Background Art

Assigning and otherwise processing vehicle repossessions involves a myriad of business tasks including but not limited to registering contractors to perform the repossessions, assigning repossession assignments to the contractors, accepting the repossession assignments, conducting the repossession and contractor follow-up with the creditor issuing the repossession assignment (i.e., vehicle condition reports, contractor invoices, etc.).

Conventionally, communication between creditor and repossession contractors is conducted in a decentralized manner utilizing telephones, facsimile machines, and postal mail. These conventional methods, however, tend to be redundant, time consuming, error-prone, and overall inefficient. What is needed is an online method and system for automating these and other tasks associated with vehicle repossession assignments which reduces or eliminates the many drawbacks associated with conventional methodologies.

### SUMMARY OF INVENTION

One object of the present invention is to provide centralized online administration of vehicle repossession assignments that are globally accessible by distributed vehicle repossession contractors (“contractors”). The advantage of this object is a decrease in paper handling, redundancy, inaccuracy, and general inefficiency associated with more conventional modes of communication (i.e., facsimile, telephone, mail, etc.).

Another object of the present invention is to provide a more efficient system for presenting new vehicle assignments, and updates thereto, to distributed contractors. The advantage of this object is a reduction in the amount of time which transpires between the time a decision to repossess a vehicle is made and the time the repossession ultimately takes place. In many cases, there is a direct relationship between this time span and the difficulty and cost associated with the repossession.

Yet another object of the present invention is to provide a centralized source of data associated with vehicle repossessions. This object is advantageous because it facilitates accounting and informative data mining such as a quantitative comparison of repossession contractors with respect to number of assignments they each have accepted, fees, time to complete repossession, etc.

To meet these and other objects and advantages of the present invention, preferred and alternate embodiments of an online system for issuing vehicle repossession assignments to vehicle repossession contractors are provided. The system includes at least one server computer operably serving at least one client computer. The at least one server computer is configured to host a secure online account for a vehicle repossession contractor. The online account is remotely and securely accessible by the contractor and maintains at least one vehicle repossession assignment that has been assigned to the contractor. The at least one server computer is additionally configured to receive input from the contractor containing feedback regarding a vehicle repossession assignment that has been completed.

The at least one server computer may be additionally configured to receive input from the contractor accepting or declining the at least one vehicle repossession assignment.

The at least one server computer may be additionally configured to receive input defining a profile for the contractor.

The feedback may include a vehicle condition report for a repossessed vehicle, an invoice for a vehicle repossession assignment that has been performed, or a listing of personal property found within a vehicle that has been repossessed.

The at least one server computer may be additionally configured to receive input and present output suspending or canceling a pending repossession assignment.

The at least one server computer may be additionally configured to initiate a notification to the contractor indicating that a new vehicle repossession assignment is pending at the contractor's online account.

Additionally, preferred and alternate embodiments of an online method for delivering vehicle repossession assignments is provided. The method includes establishing a secure online account for a vehicle repossession contractor wherein the online account is remotely and securely accessible by the contractor, delivering at least one vehicle repossession assignment to the contractor wherein the at least one vehicle repossession assignment is added to the contractor's online account, and receiving input from the contractor containing feedback regarding a completed vehicle repossession assignment.

The method may additionally include receiving input from the contractor accepting or declining the at least one vehicle repossession assignment.

The method may additionally include defining an online profile for the contractor.

The feedback may include an online vehicle condition report for a repossessed vehicle, an online invoice for a vehicle repossession assignment that has been performed, or an online listing of personal property found within a vehicle that has been repossessed.

The method may additionally include suspending or canceling a pending repossession assignment.

The method may additionally include notifying a contractor that a new vehicle repossession assignment is pending at the contractor's online account.

The above objects and other objects, features, and advantages of the present invention are readily apparent from the following detailed description of the best mode for carrying out the invention when taken in connection with the accompanying drawings.

### BRIEF DESCRIPTION OF DRAWINGS

FIG. 1 is a schematic diagram illustrating a preferred embodiment of a system for implementing the present invention;

FIG. 2 is a block flow diagram illustrating a preferred methodology for implementing the present invention;

FIGS. 3a and 3b are collectively a graphical user interface (GUI) for receiving input defining a contractor profile in accord with a preferred embodiment of the present invention;

FIG. 4 is a GUI for presenting a new vehicle repossession assignment in accord with a preferred embodiment of the present invention;

FIGS. 5a and 5b are collectively a GUI for presenting a online summary of a contractor's outstanding vehicle repossession assignments in accord with a preferred embodiment of the present invention;

FIGS. 6a and 6b are collectively a graphical user interface (GUI) for receiving input defining a vehicle condition report in accord with a preferred embodiment of the present invention;

FIG. 7 is a graphical user interface (GUI) for receiving input defining an invoice for a performed vehicle repossession assignment in accord with a preferred embodiment of the present invention; and

FIG. 8 is a graphical user interface (GUI) for receiving input defining a vehicle personal property listing in accord with a preferred embodiment of the present invention.

### DETAILED DESCRIPTION

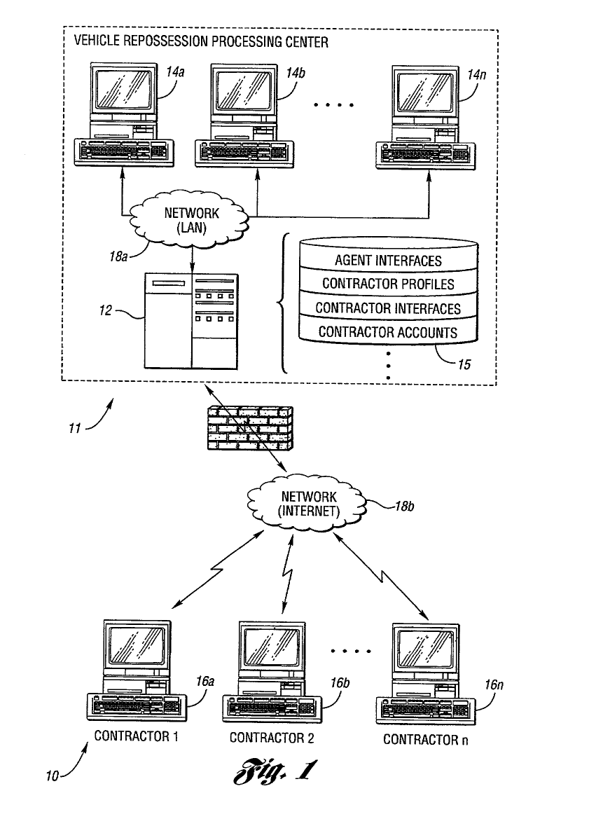

FIG. 1 is a schematic diagram illustrating a preferred system 10 for implementing the present invention. System 10 comprises at least one server computer 12 operably serving a plurality of repossession agent client computers 14A-14N and repossession contractor client computers 16A-16N via networks 18A and 18B, respectively. Computer networks 18A and 18B comprise any one or more of a variety of computer communication configurations including but not limited to a local area network (LAN), a wide area network (WAN), a wireless network, an intranet, an extranet and the Internet.

In accord with a preferred embodiment of the present invention, client computers 14A-14N communicate with server computer 12 utilizing a TCP-IP communication protocol via network/LAN 18A. Client computers 16A-16N preferably communicate with server computer 12 utilizing a TCP-IP communication protocol via the Internet, including HTTP protocol.

Server computer 12 is configured to operably store data to, and retrieve information from, at least one database 15.

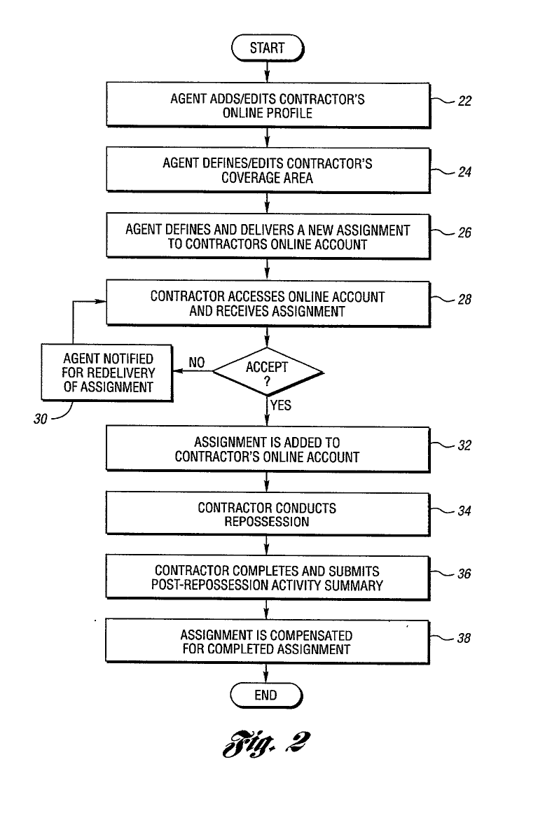

FIG. 2 is a block flow diagram illustrating a preferred methodology 20 for implementing the present invention. As represented in block 22, a vehicle repossession agent (“agent”) adds a contractor's online profile to a data table of authorized contractors contained within database 15 (as best shown in FIG. 1). Once added to database 15, a contractor's online profile may be accessed by the agent to update contractor profile information as necessary to keep the contractor's online profile up to date.

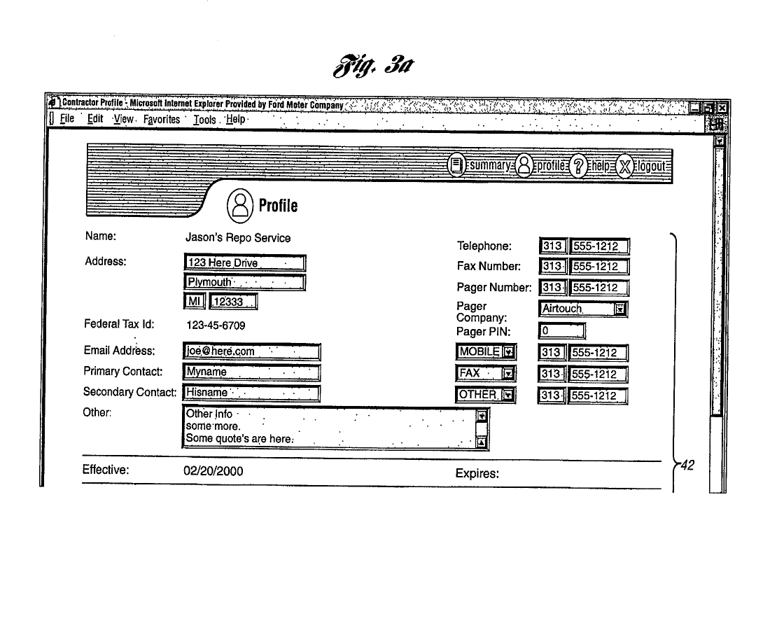

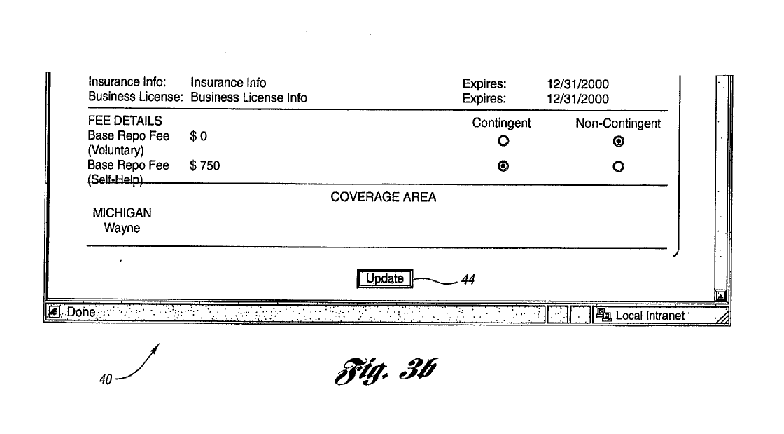

FIG. 3 illustrates a preferred graphical user interface (GUI) 40 hosted by server 12 for adding/editing contractor profiles in accord with the present invention. GUI 40, like other GUls provided in accord with the present invention, may be developed and/or configured utilizing a plurality of client-server interface languages and applications including but not limited to hypertext markup language (HTML), Java Servlets and Java Script.

GUI 40 comprises a plurality of data input fields 42 for defining a contractor profile in accord with the present invention. Data input fields 42 for defining a contractor profile include but are not limited to: company name, contractor login I.D., effective date, expiration date, contractor business code, contractor type code, super branch code, address, e-mail address, contractor fee amount, voluntary contractor fee amount, federal tax I.D., contingency indicator, voluntary contingency indicator, primary and secondary contact, business license expiration date, insurance expiration date, fax, telephone and pager number, business license text, insurance text, and miscellaneous notes.

Upon selecting the “Update” button 44, data input into data fields 42 is automatically added to an online profile for the corresponding contractor contained within database 15. Preferably, server 12 automatically establishes an online account for the contractor once the contractor's online profile is complete and valid and/or approved.

As discussed in greater detail below, an authorized contractor having a valid online profile will be assigned a unique user ID and password for remotely and securely accessing his or her online account. Preferably, the authorized contractor accesses the secured online account via a Web browser in operable communication with server computer 12 through the World Wide Web.

In addition to defining the contractor's online profile, the agent accesses an online interface (not shown), for defining or editing the contractor coverage area. Preferably, this GUI enables an agent to select or reselect, for a particular contractor, the state(s) and corresponding cities or counties that fall within that contractor's coverage area.

At this point in the preferred methodology illustrated in FIG. 2, a contractor having a valid profile is enabled to receive new repossession assignments via the contractor's online account hosted at server computer 12.

As represented in block 26, an agent accesses an online interface hosted by server computer 12 to define and assign a new repossession assignment to an authorized contractor (i.e., a contractor having a valid profile and online account at server computer 12).

As represented in block 26, an agent accesses an online interface (not shown) to define a new repossession assignment and deliver the assignment electronically to an appropriate authorized contractor. In accord with a preferred embodiment of the present invention, each new online assignment comprises information including but not limited to an assignment tracking number, a vehicle description, a vehicle identification number, vehicle buyer information (e.g., name, address, phone number, etc.), and assignment information (e.g., type of surrender, fee, number of days past due, balance, amount past due, payment amount, contractor name, and directions/special instructions).

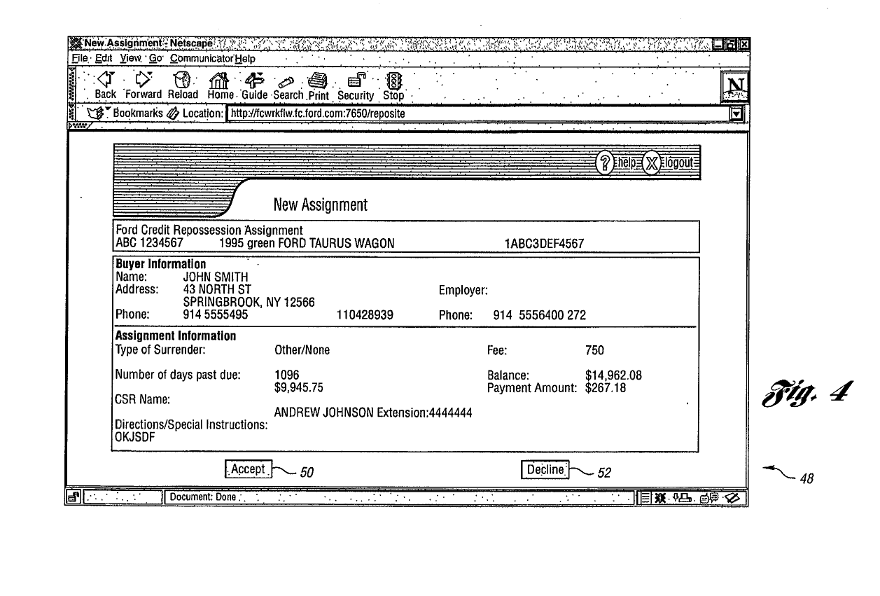

FIG. 4 illustrates a preferred GUI containing a new repossession assignment generated by an agent in accord with the present invention. In accord with a preferred embodiment of the present invention, once an online repossession assignment is defined by an agent and assigned to a particular contractor, that contractor is automatically presented with the online repossession assignment (i.e., GUI 48) upon the contractor's next login into his or her online account hosted at server computer 12, as represented in FIG. 2, block 28. Preferably, the contractor receiving a new assignment cannot access any other aspect of his or her online account until the online assignment shown in FIG. 4 is either accepted or declined as a result of the contractor selecting the (“Accept”) or (“Decline”) buttons 50 and 52, respectively. Should the contractor decline the new assignment, an agent is electronically notified and the new repossession assignment is assigned by the agent (or assigned automatically) to another contractor, as represented in block 30. Should the contractor accept the assignment, the new assignment is automatically added to the contractor's online repossession account summary, as represented in FIG. 2, block 32 and discussed in greater detail below.

In the event that an online repossession assignment is delivered to a contractor who, at the time of delivery, is logged into his or her online account at server 12, new assignment GUI 48 is automatically presented (or a pop-up message having a link thereto). Additionally, server computer 12 may be configured to automatically page, e-mail, or otherwise notify a contractor that a new repossession assignment has been delivered and is pending. Notably, pager number, e-mail address and other contact information for each contractor is defined within each contractor's online profile illustrated and discussed with respect to FIG. 3.

In addition to the new online assignment illustrated in FIG. 4, an agent may define and deliver to a contractor's online account a repossession hold assignment or a repossession cancel assignment (not shown). A repossession hold assignment is similar in appearance to the new repossession assignment shown in FIG. 4. This interface is used to notify a contractor to suspend any repossession activity on a previously assigned assignment for a specified period of time. Preferably, a contractor receiving this hold notice selects an “Acknowledge” button provided therewith before proceeding to accept any new assignment or manage any other outstanding assignments within the contractor's online account.

A repossession cancel assignment is similar in appearance to the new repossession assignment shown in FIG. 4. This interface is used to notify a contractor to indefinitely cancel any repossession activity associated with a previously accepted repossession assignment. Like the other preferred assignment interfaces previously discussed, a contractor receiving the cancel notice acknowledges the notice before proceeding to accept a new assignment or manage any outstanding assignments within the contractor's online account summary.

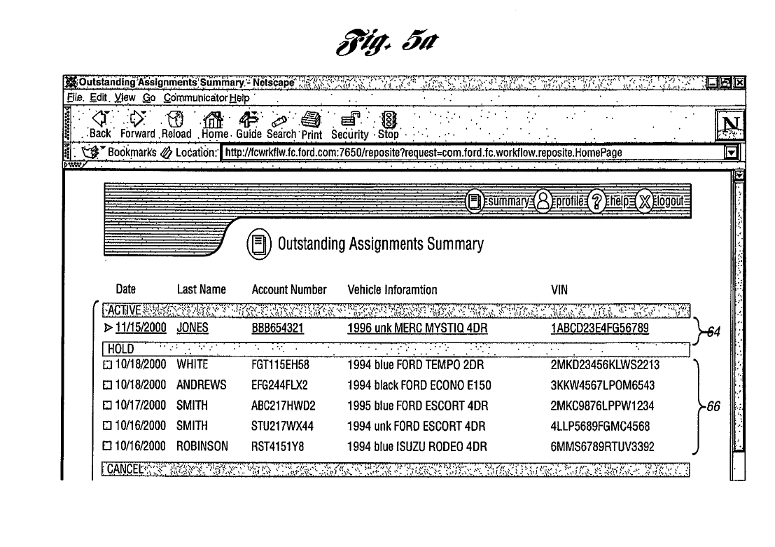

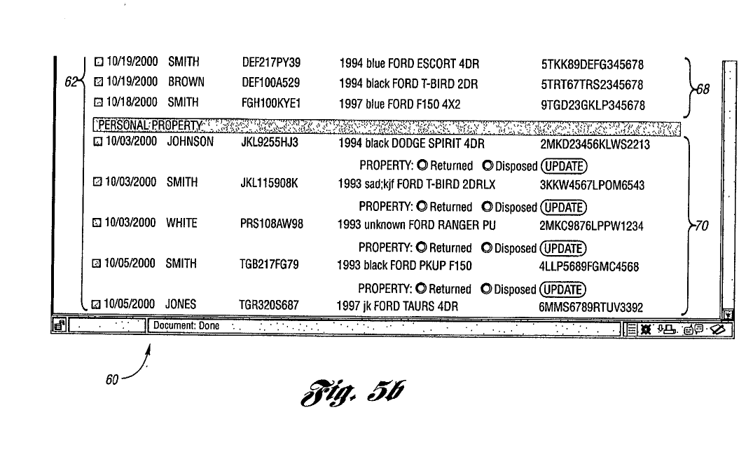

Referring now to FIG. 5, a preferred GUI 60 containing a contractor's online repossession account summary 62 in accord with the present invention is illustrated. Online account summary 62 comprises a listing of active repossession assignments 64, hold repossession assignments 66, cancelled repossession assignments 68 and a personal property listing 70 for completed repossession assignments.

In accord with a preferred embodiment of the present invention, each active repossession assignment 64 listed in the contractor's online account summary 62 contains a hyperlink to a corresponding online assignment detail summary to be completed following the completion of the repossession assignment, as represented in FIG. 2, block 36. In accord with this preferred embodiment, the online assignment detail summary comprises assignment details (similar to assignment interface illustrated in FIG. 4), a vehicle condition report (VCR), an invoice, and a personal property listing.

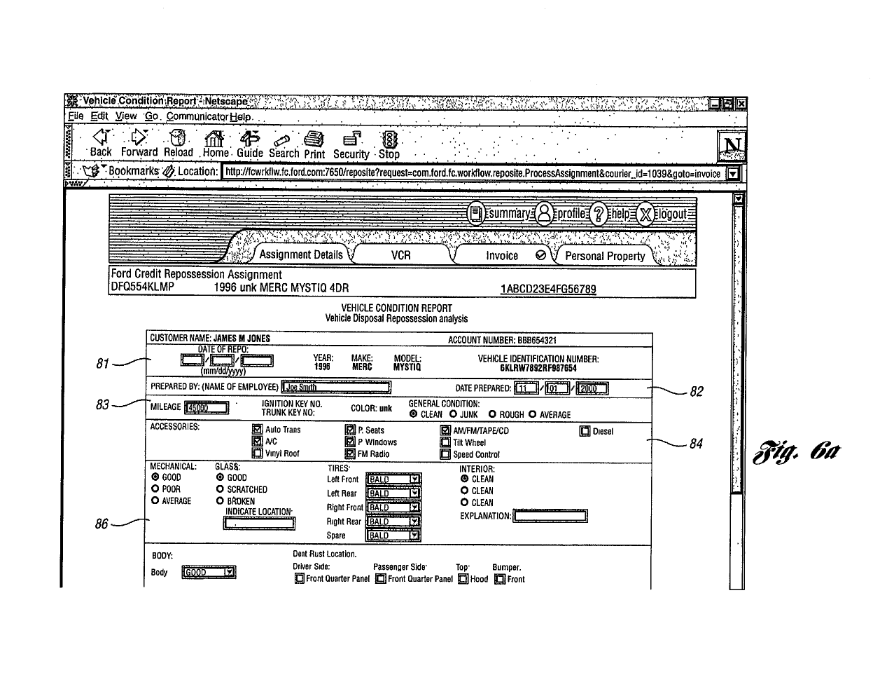

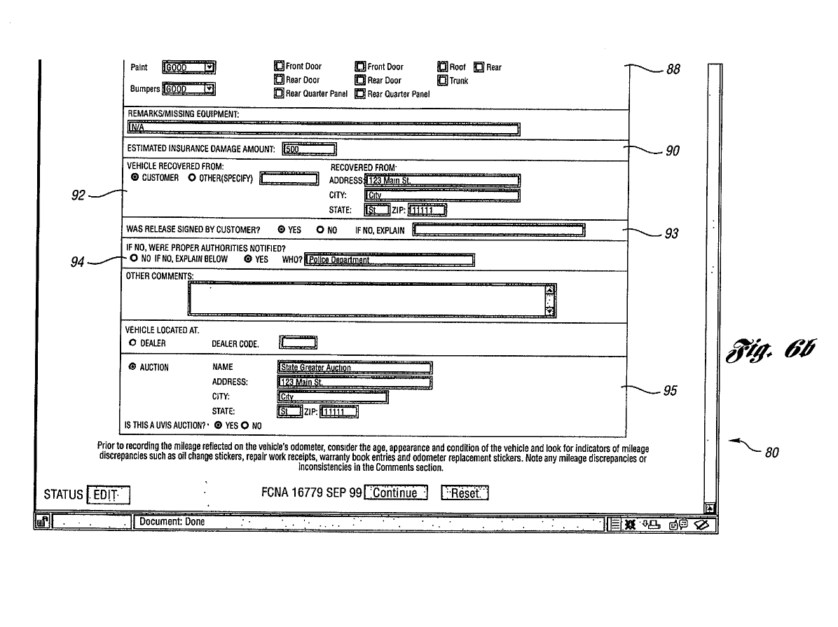

FIG. 6 illustrates a contractor interface 80 for defining a VCR in accord with the present invention. Vehicle condition report 80 comprises a plurality of data input or selection fields including but not limited to the date of repossession 81, the VCR preparer's name and date prepared 82, vehicle mileage and general condition 83, vehicle accessories 84, general mechanical, glass, tire and interior conditions 86, general body condition including dent and rust locations 88, an estimated insurance damage amount 90, vehicle recovery location 92, customer sign-off 93, authority notification 94, and current vehicle location 95.

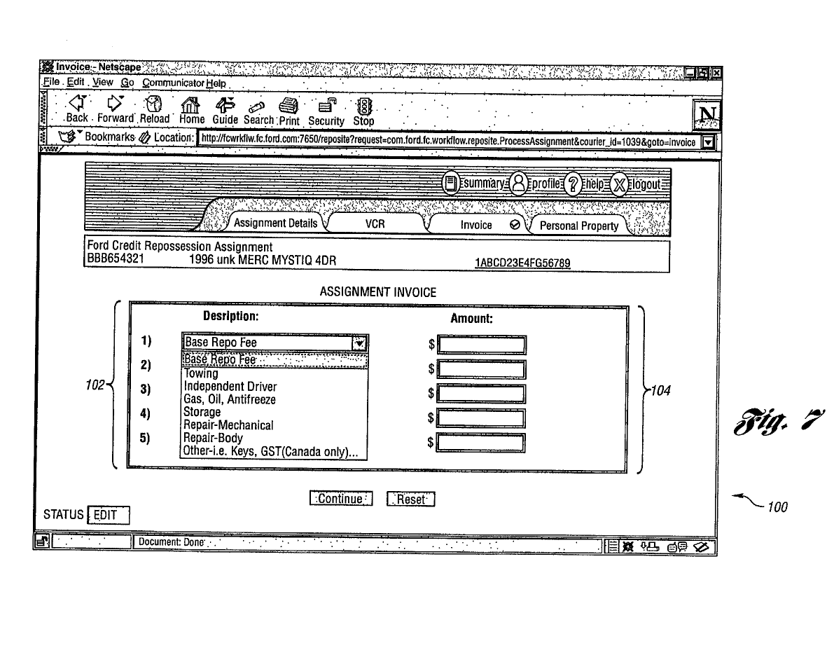

FIG. 7 illustrates an online invoice 100 for a completed repossession assignment in accord with the present invention. The invoice is an online form used to submit a contractor's outstanding bill and expenses that were incurred while repossessing a vehicle. More particularly, the assignment invoice comprises a plurality of selectable description and corresponding amount fields 102 and 104, respectively. Invoice descriptions 102 include but are not limited to a base repossession fee, towing fee, an independent driver fee, gas, oil and antifreeze costs, storage costs, mechanical repair costs, body repair costs, and miscellaneous costs.

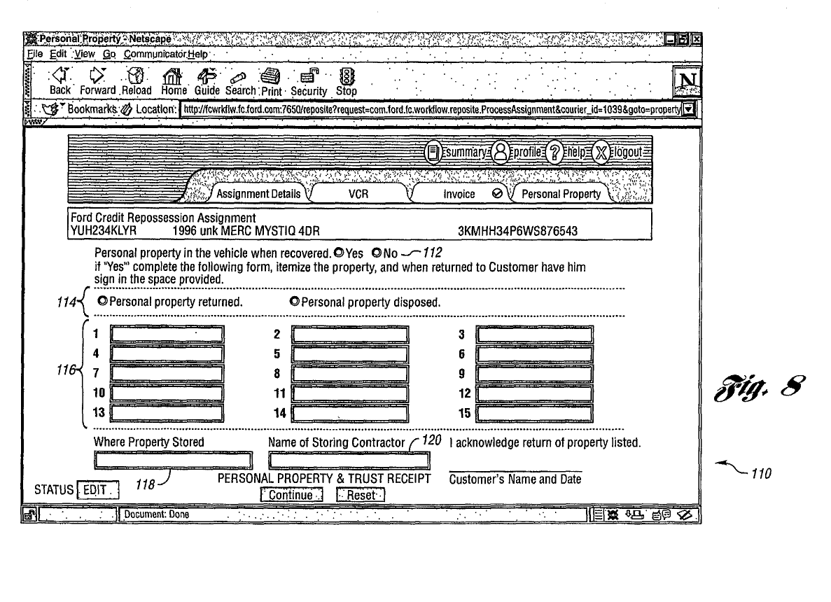

FIG. 8 illustrates a contractor's online interface 110 for identifying personal property found within a vehicle following a completed repossession assignment. The personal property listing 110 comprises an indication 112 as to whether or not personal property was in the vehicle when recovered, an indication 114 as to whether the personal property was returned or disposed, an itemized listing 116 of each personal property item found within the vehicle upon repossession, an indication 118 as to where the property is currently stored and an indication 120 of the name of the entity storing the property.

In accord with a preferred embodiment of the present invention, the vehicle repossession processing center 11 compensates a contractor for a completed repossession assignment following his or her submission of the corresponding online assignment detail summary, as represented in FIG. 2, block 38.

Referring again to FIG. 5, a contractor accessing his or her online account summary may select a “profile” hyperlink 69 to access a contractor interface (not shown) for updating various aspects of the contractor's online profile originally defined by the creditor agent as discussed above.

Preferably, the contractor's profile interface only allows the contractor to update his or her current address, primary and secondary contacts, pager and phone number fields. All other information is preferably maintained by the creditor agent, as discussed with respective FIG. 3.

While the best mode for carrying out the invention has been described in detail, those familiar with the art to which this invention relates will recognize various alternative designs and embodiments for practicing the invention as defined by the following claims.

1. An online system for issuing vehicle repossession assignments to vehicle repossession contractors, the system comprising at least one server computer operably serving at least one client computer, the at least one server computer configured to:
(i) host a secure online account for a vehicle repossession contractor wherein the online account is securely and remotely accessible by the contractor;
(ii) receive input assigning at least one vehicle repossession assignment to the contractor wherein the at least one vehicle repossession assignment is added to the contractor's online account; and
(iii) receive input containing feedback from the contractor regarding a vehicle repossession assignment that has been completed.

2. The system of claim 1 wherein the at least one server computer is additionally configured to receive input from the contractor accepting or declining the at least one vehicle repossession assignment.

3. The system of claim 1 wherein the at least one server computer is additionally configured to receive input defining a profile for the contractor.

4. The system of claim 1 wherein the feedback includes a vehicle condition report for a repossessed vehicle.

5. The system of claim 1 wherein the feedback includes an invoice for a vehicle repossession assignment that has been performed.

6. The system of claim 1 wherein the feedback includes a listing of personal property found within a vehicle that has been repossessed.

7. The system of claim 1 wherein the at least one server computer is additionally configured to receive input and present output suspending or canceling a pending repossession assignment.

8. The system of claim 1 wherein the at least one server computer is additionally configured to initiate a notification to the contractor indicating that a new vehicle repossession assignment is pending at the contractor's online account.

9. An online method for delivering vehicle repossession assignments, the method comprising:
establishing a secure online account for a vehicle repossession contractor wherein the online account is securely and remotely accessible by the contractor;
delivering at least one vehicle repossession assignment to the contractor wherein the at least one vehicle repossession assignment is added to the contractor's online account; and
receiving input from the contractor containing feedback regarding a completed vehicle repossession assignment.

10. The method of claim 9 additionally comprising receiving input from the contractor accepting or declining the at least one vehicle repossession assignment.

11. The method of claim 9 additionally comprising defining an online profile for the contractor.

12. The method of claim 9 wherein the feedback includes an online vehicle condition report for a repossessed vehicle.

13. The method of claim 9 wherein the feedback includes an online invoice for a vehicle repossession assignment that has been performed.

14. The method of claim 9 wherein the feedback includes an online listing of personal property found within a vehicle that has been repossessed.

15. The method of claim 9 additionally comprising suspending or canceling a pending repossession assignment.

16. The method of claim 9 additionally comprising notifying a contractor that a new vehicle repossession assignment is pending at the contractor's online account.

17. An online system for issuing vehicle repossession assignments to vehicle repossession contractors, the system comprising:
(i) a means for hosting a secure online account for a vehicle repossession contractor wherein the online account is securely and remotely accessible by the contractor; and
(ii) a means for assigning at least one vehicle repossession assignment to the contractor wherein the at least one vehicle repossession assignment is added to the contractor's online account; and
(iii) a means for receiving input from the contractor containing feedback regarding a completed vehicle repossession assignment.

18. The system of claim 17 additionally comprising a means for receiving input from the contractor accepting or declining the at least one vehicle repossession assignment.

19. The system of claim 17 additionally comprising a means for defining a profile for the contractor.

20. The system of claim 17 wherein the feedback includes a vehicle condition report for a repossessed vehicle.

21. The system of claim 17 wherein the feedback includes an invoice for a vehicle repossession assignment that has been performed.

22. The system of claim 17 wherein the feedback includes a listing of personal property found within a vehicle that has been repossessed.

23. The system of claim 17 additionally comprising a means for suspending or canceling a pending repossession assignment.

24. The system of claim 17 additionally comprising a means for initiating a notification to the contractor indicating that a new vehicle repossession assignment is pending at the contractor's online account.
